(19) United States
(12) Patent Application Publication
(10) Pub. No.: US 2026/0019143 A1
(43) Pub. Date: Jan. 15, 2026

(54) DIGITAL SELF-INTERFERENCE CANCELLATION FOR MIMO REPEATER

(71) Applicant: Samsung Electronics Co., Ltd., Suwon-si (KR)

(72) Inventors: Fahid Hassan, Houston, TX (US); Chance Anthony Tarver, Arlington, TX (US); Matthew Tonnemacher, Allen, TX (US); Gang Xu, Allen, TX (US)

(21) Appl. No.: 19/006,083

(22) Filed: Dec. 30, 2024

Related U.S. Application Data
(60) Provisional application No. 63/670,662, filed on Jul. 12, 2024.

(51) Int. Cl. H04B 7/155; H04B 7/0413

(52) U.S. Cl. CPC H04B 7/15564; H04B 7/0413

(57) ABSTRACT

A multiple-input, multiple-output (MIMO) repeater includes a plurality of transceiver pairs. Each transceiver pair includes a first transceiver configured to transmit and receive radio frequency (RF) signals to and from a base station (BS) via a first antenna, and a second transceiver configured to transmit and receive RF signals to and from at least one user equipment (UE) via a second antenna. The MIMO repeater also includes a processor operatively coupled to each transceiver of the plurality of transceiver pairs. The processor is configured to, for each transceiver pair: filter, via a self-interference cancellation (SIC) filter, an RF signal received from one of the first antenna or the second antenna; subtract an output of the SIC filter from the RF signal to generate a filtered RF signal; and transmit, via the other of the first antenna or the second antenna, the filtered RF signal.

### CROSS-REFERENCE TO RELATED APPLICATION(S) AND CLAIM OF PRIORITY

This application claims priority under 35 U.S.C. § 119 (e) to U.S. Provisional Patent Application No. 63/670,662 filed on Jul. 12, 2024. The above-identified provisional patent application is hereby incorporated by reference in its entirety.

### TECHNICAL FIELD

This disclosure relates generally to wireless networks. More specifically, this disclosure relates to digital self-interference cancelation for multiple-input, multiple-output (MIMO) repeaters.

### BACKGROUND

C-band (3.7-4.2 GHZ) fixed wireless access (FWA) nodes are being deployed as an alternative to fiber installations in 5G. In FWA, the Customer Premise Equipment (CPE) is connected to the base station (BS) by wireless radio waves instead of fiber-optic cables. Consequently, FWA is envisioned to provide 5G internet access in areas where wired infrastructure is limited or costly to deploy. However, C-band frequencies suffer high path loss compared to lower frequency bands, which can limit the FWA node range of coverage. In addition, C-band experiences significant wall penetration loss, which can limit the indoor coverage of the network.

### SUMMARY

This disclosure provides apparatuses and methods for digital self-interference cancellation for MIMO repeaters.

In one embodiment, a multiple-input multiple-output (MIMO) repeater is provided. The MIMO repeater includes a plurality of transceiver pairs. The MIMO repeater also includes a processor operatively coupled to each transceiver of the plurality of transceiver pairs. The processor is configured to, for each transceiver pair: filter, via a self-interference cancellation (SIC) filter, an RF signal received from one of a first antenna or a second antenna of the transceiver pair; subtract an output of the SIC filter from the RF signal to generate a filtered RF signal; and transmit, via the other of the first antenna or the second antenna, the filtered RF signal.

In another embodiment, a method of operating a MIMO repeater is provided. The method includes, for each of a plurality of transceiver pairs comprised by the MIMO repeater, filtering, via a SIC filter, an RF signal received from one of a first antenna or a second antenna of the transceiver pair. The method also includes, for each of the plurality of transceiver pairs, subtracting an output of the SIC filter from the RF signal to generate a filtered RF signal, and transmitting, via the other of the first antenna or the second antenna, the filtered RF signal.

In yet another embodiment, a non-transitory computer readable medium embodying a computer program is provided. The computer program includes program code that, when executed by a processor of a device, causes the device to, for each of a plurality of transceiver pairs comprised by the device, filter, via a SIC filter, an RF signal received from one of a first antenna or a second antenna of the transceiver pair. The program code, when executed by the processor of the device, also causes the device to, for each of the plurality of transceiver pairs, subtract an output of the SIC filter from the RF signal to generate a filtered RF signal, and transmit, via the other of the first antenna or the second antenna, the filtered RF signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example wireless network including a MIMO repeater according to embodiments of the present disclosure;

FIG. 5 illustrates an example MIMO repeater according to embodiments of the present disclosure;

FIG. 6 illustrates an example MIMO repeater with D-SIC according to embodiments of the present disclosure;

FIG. 7 illustrates another example MIMO repeater with D-SIC according to embodiments of the present disclosure;

FIG. 8 illustrates an example method for operating a MIMO repeater with D-SIC according to embodiments of the present disclosure;

FIG. 9 illustrates another example method for operating a MIMO repeater with D-SIC according to embodiments of the present disclosure; and

FIG. 10 illustrates another example method for operating a MIMO repeater with D-SIC 900 according to embodiments of the present disclosure.

### DETAILED DESCRIPTION

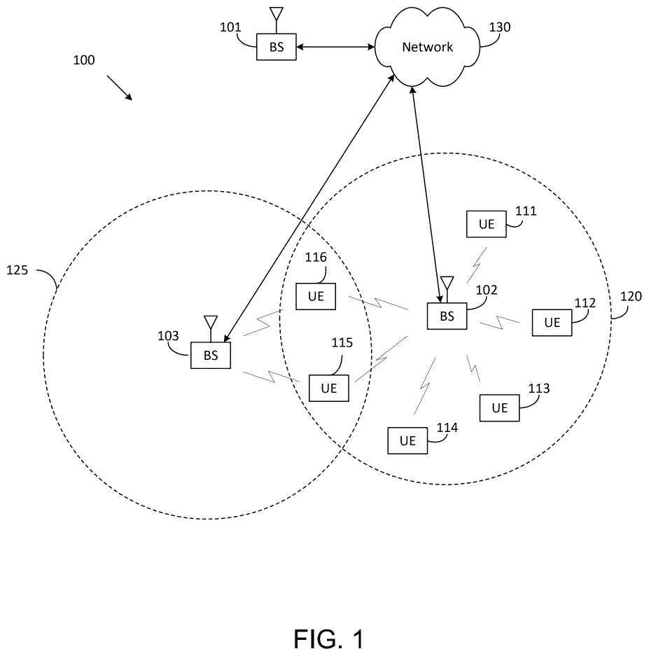

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” “customer premise equipment (CPE),” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support communication in a wireless communication system with a MIMO repeater that includes digital self-interference cancellation. In certain embodiments, one or more of the gNBs 101-103 includes circuitry, programing, or a combination thereof, to support communication in a wireless communication system with a MIMO repeater that includes digital self-interference cancellation.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

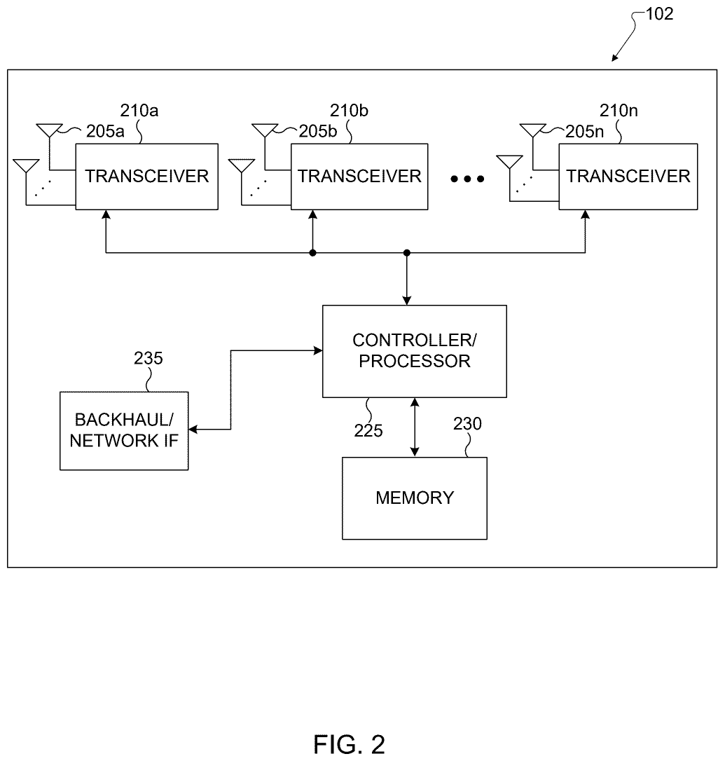

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support communication in a wireless communication system with a MIMO repeater that includes digital self-interference cancellation as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

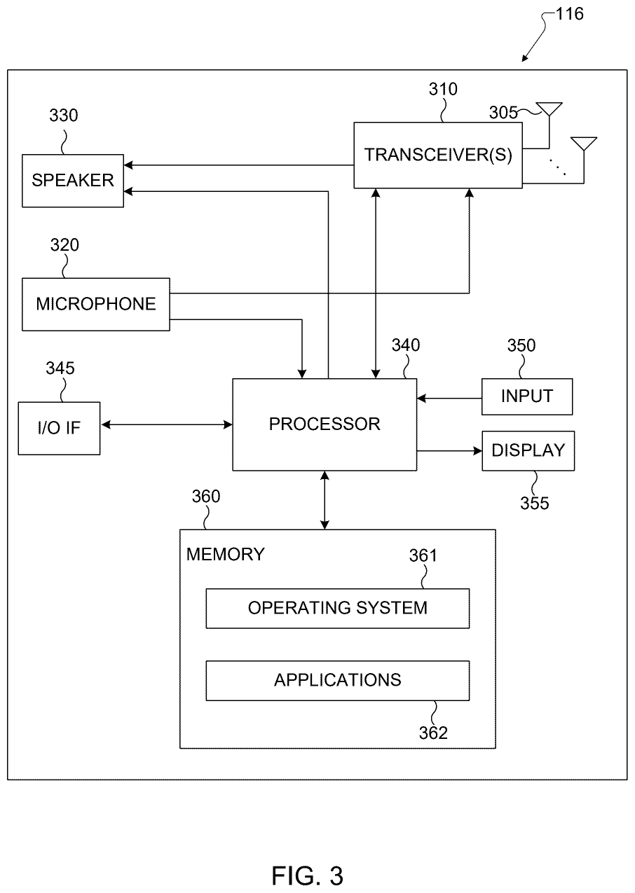

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for communication in a wireless communication system with a MIMO repeater that includes digital self-interference cancellation as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

In some wireless networks, for example wireless networks providing fixed wireless access (FWA) services, a signal repeater may be employed to boost the node coverage of a BS. Signal repeaters are used in wireless and wireline communication systems to overcome excessive path loss. The main function of a signal repeater is to receive, amplify, and retransmit an up-link and/or down-link signal without signal quality degradation. In the present disclosure a signal repeater may also be referred to as a wireless repeater or a repeater.

Low-cost, amplify-and-forward multiple-input-multiple-output (MIMO) repeaters can provide a great solution to overcome path and wall penetration losses and extend C-band coverage. In addition to coverage extension, a MIMO repeater can provide additional throughput gains.

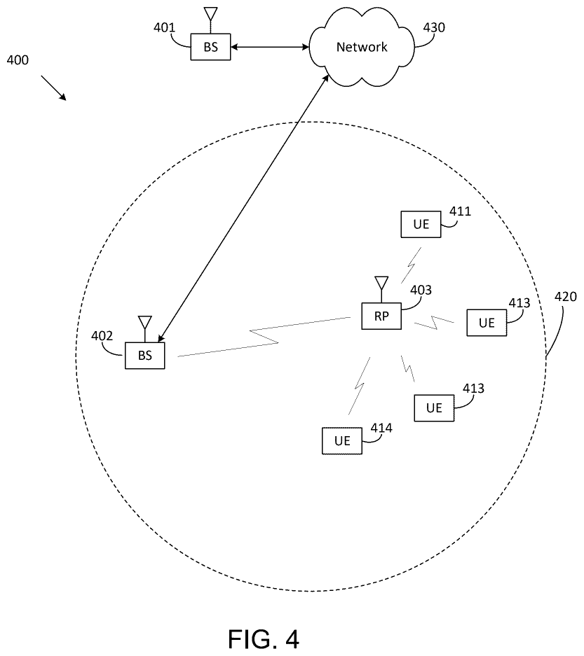

FIG. 4 illustrates an example wireless network 400 including a MIMO repeater according to embodiments of the present disclosure. The embodiment of the wireless network 400 shown in FIG. 4 is for illustration only. Other embodiments of the wireless network 400 could be used without departing from the scope of this disclosure.

As shown in FIG. 4, the wireless network includes a gNB 401 (e.g., base station, BS), a gNB 402, and a MIMO repeater (RP) 403. The gNB 401 communicates with the gNB 402. The gNB 401 also communicates with at least one network 430, such as the Internet, a proprietary Internet Protocol (IP) network, or other data network.

The gNB 402 provides wireless broadband access to the network 430 for a plurality of user equipments (UEs) within a coverage area 420 of the gNB 402. The plurality of UEs includes a UE 411, 412, 413, and 414 which may be located in a home or small business with a poor line of site to gNB 402. To improve communication with UEs 411-414, MIMO repeater 403 may be located in or near homes or small businesses where UEs 411-414 are operating, and may relay signals between gNB 402 and UEs 411-414. In some embodiments, one or more of the gNBs 401-402 and MIMO repeater 403 may communicate with each other and with the UEs 411-414 using 5G/NR, long term evolution (LTE), long term evolution-advanced (LTE-A), WiMAX, WiFi, or other wireless communication techniques.

Dotted lines show the approximate extents of the coverage area 420 a which is shown as approximately circular for the purposes of illustration and explanation only. It should be clearly understood that the coverage areas associated with gNBs, such as the coverage area 420 may have other shapes, including irregular shapes, depending upon the configuration of the gNBs and variations in the radio environment associated with natural and man-made obstructions.

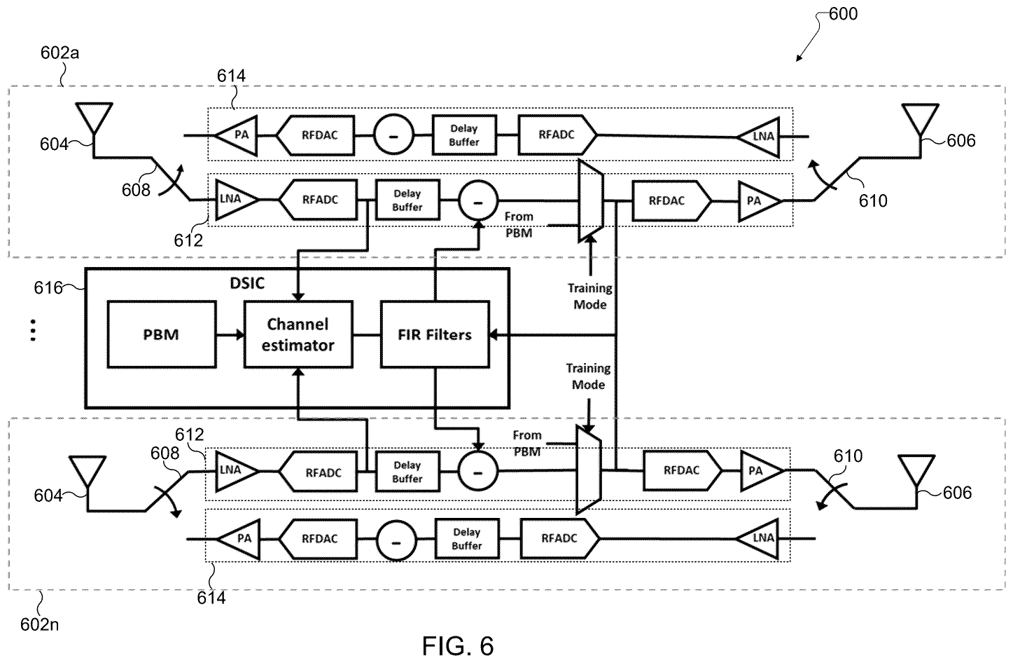

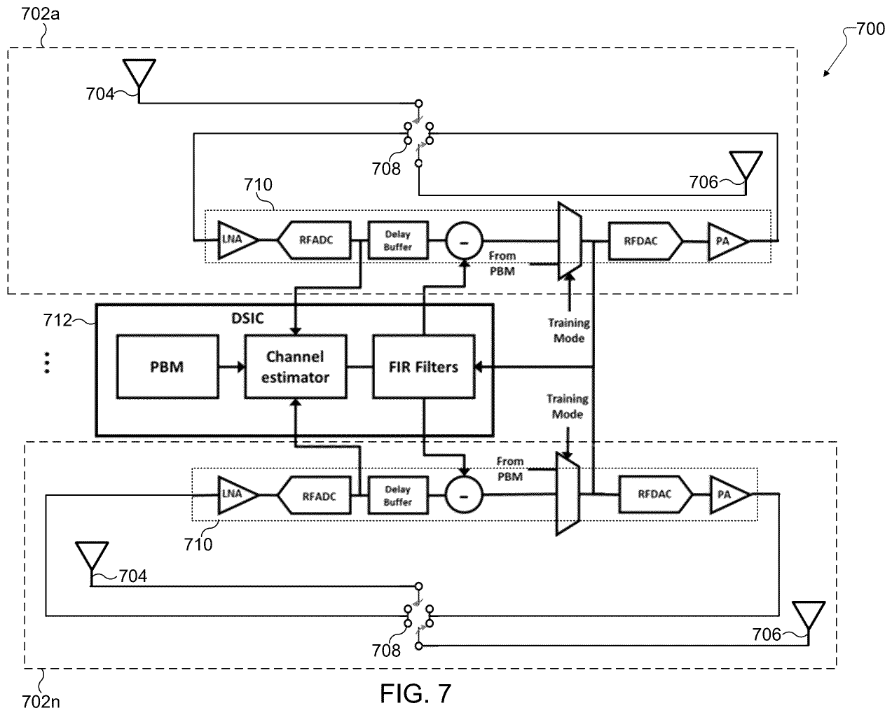

Similar as previously described regarding UEs 111-116 of FIG. 1, one or more of the UEs 411-414 include circuitry, programing, or a combination thereof, for communication in a wireless communication system with a MIMO repeater that includes digital self-interference cancellation. In certain embodiments, one or more of the gNBs 401-402 and MIMO repeater 403 includes circuitry, programing, or a combination thereof, to support communication in a wireless communication system with a MIMO repeater that includes digital self-interference cancellation similar as previously described. For example, MIMO repeater 403 may incorporate digital self-interference cancellation components similar as described in more detail below regarding FIG. 6 and FIG. 7.

Although FIG. 4 illustrates one example of a wireless network 400, various changes may be made to FIG. 4. For example, the wireless network could include any number of gNBs, any number of repeaters, and any number of UEs in any suitable arrangement. Also, the gNB 401 could communicate directly with any number of UEs and provide those UEs with wireless broadband access to the network 130. Similarly, gNB 402 could communicate directly with the network 430 and provide UEs with direct wireless broadband access to the network 430. Further, the gNBs 401 and 402 could provide access to other or additional external networks, such as external telephone networks or other types of data networks.

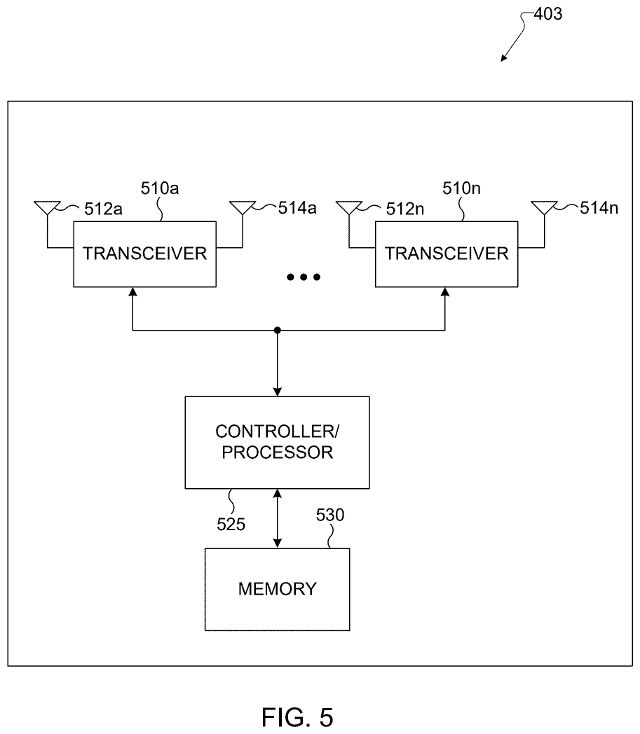

FIG. 5 illustrates an example MIMO repeater 403 according to embodiments of the present disclosure. The embodiment of the repeater illustrated in FIG. 5 is for illustration only, other repeaters could have the same or similar configuration. However, repeaters come in a wide variety of configurations, and FIG. 5 does not limit the scope of this disclosure to any particular implementation of a MIMO repeater.

As shown in FIG. 5, the MIMO repeater 403 includes multiple transceivers 510a-510n, a controller/processor 525, and memory 530. Each of transceivers 510a-510n include a first antenna and a second antenna. For example, transceiver 510a includes a first antenna 512a and a second antenna 514a, while transceiver 510n includes a first antenna 512n and a second antenna 514n.

Each of the transceivers 510a-510n receive from their respective first antennas 512a-512n and respective second antennas 514a-514n, incoming RF signals, such as signals transmitted by gNB 402 and UEs in the network 400. In some embodiments, transceivers 510a-510n may down-convert the incoming RF signals to generate IF or baseband signals. The IF or baseband signals may be processed by receive (RX) processing circuitry in transceivers 510a-510n and/or controller/processor 525, which may generate processed baseband signals by filtering, and/or digitizing the baseband or IF signals. In some embodiments, the controller/processor 525 may further process the baseband signals. In some embodiments, each of transceivers 510a-510n may include one or more amplifier stages. An amplifier stage may include a single amplifier, an amplifier group, an amplifier set, an amplifier chain, and/or the like.

Antennas 512a-512n and 514a-514n may configured for communication with particular devices within a wireless network. For example, in some embodiments, antennas 512a-512n may be configured to transmit to and receive from gNB 402, while antennas 514a-514n may be configured to transmit to and receive from the UEs in the network 400. While antennas 512a-512n and 514a-514n are described as individual antennas, it should be understood that each of antennas 512a-512n and/or 514a-514n may comprise more than one antenna, an array of multiple antennas, etc.

In some embodiments, Transmit (TX) processing circuitry in transceivers 510a-510n and/or controller/processor 525 receive analog or digital data (such as voice data, web data, e-mail, or interactive video game data) from the controller/processor 525. The TX processing circuitry may multiplex, and/or digitize the outgoing baseband data to generate processed baseband or IF signals. In some embodiments, transceivers 510a-510n up-convert the baseband or IF signals to RF signals that are transmitted via the antennas 512a-512n and 514a-514n.

The controller/processor 525 can include one or more processors or other processing devices that control the overall operation of the MIMO repeater 403. For example, the controller/processor 425 could control the reception of UL channel signals and the transmission of DL channel signals by transceivers 510a-510n in accordance with well-known principles. The controller/processor 525 could support additional functions as well, such as more advanced wireless communication functions. For instance, the controller/processor 525 could support beam forming or directional routing operations in which outgoing/incoming signals from/to antennas 512a-512n and 514a-514n are weighted differently to effectively steer the outgoing signals in a desired direction. Any of a wide variety of other functions could be supported in the MIMO repeater 403 by the controller/processor 525.

The controller/processor 525 is also capable of executing programs and other processes resident in the memory 530, such as an OS and, for example, processes to a support or enable digital self-interference cancellation for MIMO repeater 403 as discussed in greater detail below. The controller/processor 525 can move data into or out of the memory 530 as required by an executing process.

The memory 530 is coupled to the controller/processor 525. Part of the memory 530 could include a RAM, and another part of the memory 530 could include a Flash memory or other ROM.

Although FIG. 5 illustrates one example of a MIMO repeater 403, various changes may be made to FIG. 5. For example, MIMO repeater 403 could include any number of each component shown in FIG. 5. Also, various components in FIG. 5 could be combined, further subdivided, or omitted and additional components could be added according to particular needs.

By operating in full duplex mode, a repeater can receive and transmit simultaneously on the same channel, which results in a low-latency and spectrally efficient deployment. However, in the case of a MIMO repeater signal leakage from the MIMO repeater's transmitting antennas to the MIMO repeater's receiving antennas results in interference with the received signal. This repeater self-interference (SI) potentially creates a positive feedback loop that limits the repeater's gain. Hence, self-interference cancellation (SIC) techniques are desirable to enable a stable MIMO repeater. SIC techniques used in single-input single-output (SISO) systems are not directly applicable, because SISO-like cancellation does not consider all the paths from each TX antenna to each RX antenna. Various embodiments of the present disclosure provide digital self-interference cancellation (D-SIC) that models the interference and removes the interference from the received signal, allowing an interference-free amplify and forward operation.

FIG. 6 illustrates an example MIMO repeater with D-SIC 600 according to embodiments of the present disclosure. The embodiment of a MIMO repeater with D-SIC of FIG. 6 is for illustration only. Different embodiments of a MIMO repeater with D-SIC could be used without departing from the scope of this disclosure.

In the example of FIG. 6, MIMO repeater with D-SIC 600 (hereinafter “repeater 600”) includes N transceiver pairs 602a-602n. Each of transceiver pairs 602a-602n includes a first antenna 604 separated from a second antenna 606. Each of transceiver pairs 602a-602n also include a first single pole double throw (SPDT) switch 608, and a second SPDT switch 610. Switches 608 are configured to switch antennas 604 between inputs of transceiver paths 612 and outputs of transceiver paths 614. Switches 610 are configured to switch antennas 606 between outputs of transceiver paths 612 and inputs of transceiver paths 614. In the example of FIG. 6, each of the antennas 604 and 606 are switched into transceiver paths 612. In this configuration, antennas 604 operate as RX antennas, while antennas 606 operate as TX antennas.

In the example of FIG. 6, each of the transceiver paths 612 and 614 include a low noise amplifier (LNA), a radio frequency (RF) analog-to-digital converter (RFADC), a delay buffer, an SIC filter path, a multiplexer (shown only for transceiver paths 612), an RF digital-to-analog converter (RFDAC), and a power amplifier (PA). However, it should be understood that each of the transceiver paths 612 and 614 may be of any architecture.

In the example of FIG. 6, repeater 600 also includes D-SIC circuitry 616. D-SIC circuitry 616 includes a playback memory (PBM), channel estimator, and a finite impulse response filter (FIR) for each of the transceiver paths 612 and 614. While shown as integral to D-SIC circuitry 616, it should be understood that the FIR filters could be implemented as part of the filter paths of transceiver paths 612 and 614, and that the FIR filters may simply be controlled and/or configured by D-SIC circuitry 616. In some embodiments, D-SIC circuitry 616 may be implemented as one or more discrete components. For example, D-SIC circuitry 616 may be implemented in one or application specific integrated circuits (ASICs) and/or memory devices. In some embodiments, D-SIC circuitry 616 may be implemented in a processor and associated supporting hardware. For example, the functionality of D-SIC circuitry 616 may be implemented as features of controller/processor 525, and/or memory 530 of MIMO repeater 403 of FIG. 5. In some embodiments, repeater 600 includes a training mode and a repeating mode.

In training mode, a unique training sequence is fed by the PBM via a respective multiplexer, REDAC, and PA into the TX antennas and transmitted by each TX antenna simultaneously. In addition, training sequences that correspond to each RX antenna are fed into the channel estimator. Each RX antenna receives a combination of the training sequences transformed by the self-interference channels. After initial amplification by a respective LNA, and digitization by a respective RFADC, the received combination is fed from the RFDACS to the channel estimator. With both the known training sequences sent through each TX antenna and the received signals, the channel estimator solves a problem such as a least-squares problem to learn the channel and fit the FIR filters' complex coefficients. The use of other estimation techniques other than or in addition to least-squares, such as maximum likelihood, gradient descent etc., may also be used to learn the channel and fit the FIR filters' complex coefficients.

In one embodiment, the D-SIC circuitry 616 solves a least-squares problem for FIR filters of length K, with impulse response, h [k], that minimize the squared error between each TX antenna i (e.g., antennas 606) and RX antenna j (e.g., antennas 604). The least-squares problem can be formulated as shown in equation 1:

$${h}_{j} = {argmin}_{{h}_{j}} {‖ {y}_{j} - \tilde{X} {h}_{j} ‖}^{2} , \qquad ( 1 )$$

where hⱼ= [h_{1,j} . . . h_{N,j}]^{T} is the concatenation of all filter coefficients for the N transmitted signals to the jth receive signal and \tilde{X} is given in equation 2:

$$\tilde{X} = [ \begin{matrix}{\tilde{x}}_{1}^{( 0 )} & ⋯ & {\tilde{x}}_{1}^{( K - 1 )} & {\tilde{x}}_{2}^{( 0 )} & ⋯ & {\tilde{x}}_{N}^{( K - 1 )}\end{matrix} ] . \qquad ( 2 )$$

Consider a signal x[n] delayed by k samples as

$${x}_{i}^{( k )} = {[ \begin{matrix}{0}_{k} & x ( 0 ) & x ( 1 ) & ⋯ & x ( M - 1 - k )\end{matrix} ]}^{T} ,$$

where Oₖ represents the 1×k dimensional zero vector.
With this, the solution is given through canonical least-squares as shown in equation. 3:

$${h}_{j} = {( {\tilde{X}}^{H} \tilde{X} )}^{- 1} {\tilde{X}}^{H} {y}_{j} , \qquad ( 3 )$$

where H is the Hermitian transpose. The solution is obtained for all j receive antennas, and the impulse response h_{i,j}[k] between each TX antenna j and RX antenna i can be separated from the hⱼ.

In repeating mode, Each RX antenna receives an RF signal for amplification and forwarding. After initial amplification by a respective LNA, and digitization by a respective RFADC, the received signal is fed through a delay buffer into the corresponding SIC filter path prior to being sent to the RFDACs. Each SIC filter path incorporates the FIR filter including the complex coefficients fit during the training sequence in training mode. The filters' outputs are subtracted from the incoming signals to cancel the unwanted interference. The remaining signals, comprising mainly of the intended received signals are then passed from the SIC filter paths to the respective RFDACs via the multiplexers for conversion back to RF signals before amplification by the PAs and transmission from the TX antennas for forwarding.

Although FIG. 6 illustrates an example MIMO repeater with D-SIC 600, various changes may be made to FIG. 6. For example, various changes to the transceiver paths, the number of transceivers, etc. could be made according to particular needs. For example, transceiver paths 612 and 614 could employ DACs and ADCs with up- and down-convertors instead of RFDACs and RFADCs.

In some embodiments, a MIMO repeater with D-SIC may employ transceivers with a single transceiver path, where a double pole double throw (DPDT) switch is employed to switch the antennas around the RF components as shown in FIG. 7. This has the advantage of implementing the MIMO repeater with fewer components, as well as other possible advantages such as channel reciprocity.

FIG. 7 illustrates another example MIMO repeater with D-SIC 700 according to embodiments of the present disclosure. The embodiment of a MIMO repeater with D-SIC of FIG. 7 is for illustration only. Different embodiments of a MIMO repeater with D-SIC could be used without departing from the scope of this disclosure.

In the example of FIG. 7, MIMO repeater with D-SIC 700 (hereinafter “repeater 700”) includes N transceivers 702a-702n. Each of transceivers 702a-702n includes a first antenna 704 separated from a second antenna 706, and a double pole double throw (DPDT) switch 708. Switches 708 are configured to switch antennas 704 and 706 alternately between the inputs of transceiver paths 710 and the outputs of transceiver paths 710. In the example of FIG. 7, each of the antennas 704 are switched into the inputs, and each of the antennas 706 are switched into the outputs. In this configuration, antennas 704 operate as RX antennas, while antennas 706 operate as TX antennas.

In the Example of FIG. 7, each of the transceiver paths 710 include a low noise amplifier (LNA), a radio frequency (RF) analog-to-digital converter (RFADC), a delay buffer, an SIC filter path, a multiplexer, an RF digital-to-analog converter (RFDAC), and a power amplifier (PA). However, it should be understood that each of the transceiver paths 710 may be of any architecture.

Repeater 700 also includes D-SIC circuitry 712. D-SIC circuitry 712 includes a PBM, channel estimator, and a FIR for each of the transceiver paths 710. While shown as integral to D-SIC circuitry 712, it should be understood that the FIR filters could be implemented as part of the filter paths of transceiver paths 710, and that the FIR filters may simply be controlled and/or configured by D-SIC circuitry 712. In some embodiments, D-SIC circuitry 712 may be implemented as one or more discrete components. For example, D-SIC circuitry 712 may be implemented in one or application specific integrated circuits (ASICs) and/or memory devices. In some embodiments, D-SIC circuitry 712 may be implemented in a processor and associated supporting hardware. For example, the functionality of D-SIC circuitry 712 may be implemented as features of controller/processor 525, and/or memory 530 of MIMO repeater 403 of FIG. 5.

In some embodiments, repeater 700 includes a training mode and a repeating mode. The training mode and the repeating mode may operate similar as described regarding repeater 600 of FIG. 6.

Although FIG. 7 illustrates an example MIMO repeater with D-SIC 700, various changes may be made to FIG. 7. For example, various changes to the transceiver paths, the number of transceivers, etc. could be made according to particular needs. For example, transceiver paths 710 could employ DACs and ADCs with up- and down-convertors instead of RFDACs and RFADCs.

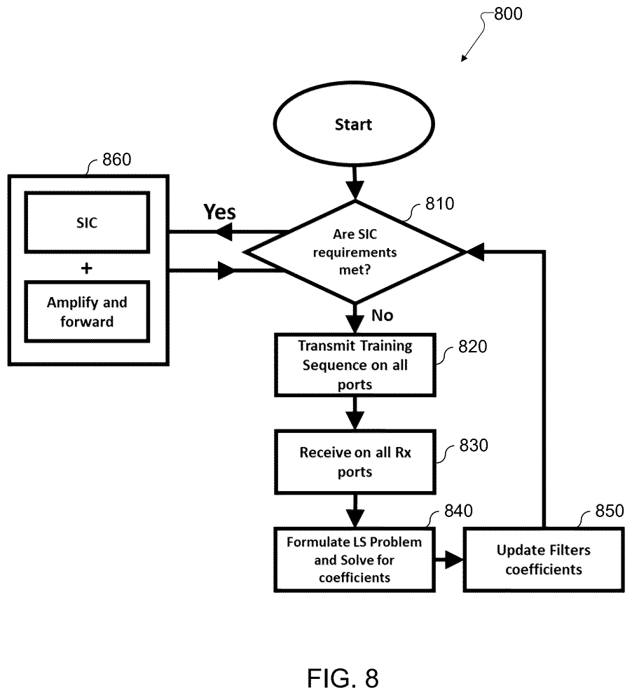

FIG. 8 illustrates an example method for operating a MIMO repeater with D-SIC 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for operating a MIMO repeater with D-SIC could be used without departing from the scope of this disclosure.

In the example of FIG. 8, method 800 begins at 810. At step 810, a MIMO repeater with D-SIC (e.g., repeater 600 of FIG. 6) determines whether SIC requirements are met. For example, during initial power on, the MIMO repeater may default to the SIC requirements not being met. For instance, the SIC filters may not have a present value for the FIR complex coefficients. In another example, during online operation, the MIMO repeater may determine that a self-interference of the MIMO repeater has exceeded a threshold. For instance, the MIMO repeater may determine that the MIMO repeater has become unstable due to self-interference, that the self-interference has become unbounded, that a signal-to-interference-plus-noise ratio (SINR) has exceeded a threshold, etc. If the SIC requirements are met, the method proceeds to step 860. Otherwise, if the SIC requirements are not met, the method proceeds to step 820.

At step 820, the MIMO repeater begins a training operation by transmitting a training sequence on all TX ports. During the training operation, all of the TX antennas transmit unique and known training signals simultaneously to learn the self-interference.

At step 830, the training signals transmitted at step 830 the training sequence is received on all RX ports. During the training operation, all of the RX antennas receive the transmissions from step 820 to learn the self-interference.

At step 840, the MIMO repeater formulates a least-squares problem between the received interference and the known transmitted signal. The least-squares problem is then solved to determine the complex coefficients of the FIR filters.

At step 850, the MIMO repeater uses the solution to the least-squares problem to update the FIR filters' coefficients to model the interference channels. The method then returns to step 810.

At step 860, the MIMO repeater receives a signal for forwarding. The received signal is passed through the SIC filters, and the SIC filter output is subtracted from the received signal, canceling the interference. The now filtered signal is amplified and forwarded. The method then returns to step 810.

Although FIG. 8 illustrates one example method for operating a MIMO repeater with D-SIC 800, various changes may be made to FIG. 8. For example, while shown as a series of steps, various steps in FIG. 8 could overlap, occur in parallel, occur in a different order, occur any number of times, be omitted, or replaced by other steps.

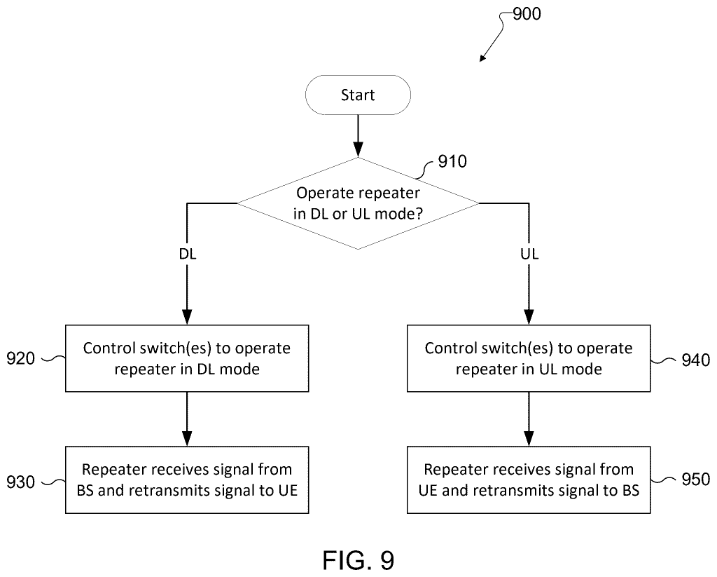

FIG. 9 illustrates another example method for operating a MIMO repeater with D-SIC 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for operating a MIMO repeater with D-SIC could be used without departing from the scope of this disclosure.

In the example of FIG. 9, method 900 begins at 910. At step 910, a MIMO repeater with D-SIC (e.g., repeater 600 of FIG. 6) determines whether to operate the repeater un a DL or UL mode. If the MIMO repeater determines to operate repeater in the DL mode, the method proceeds to step 920. If the MIMO repeater determines to operate the repeater in the UL mode, the method proceeds to step 940.

At step 920, the repeater controls one or more switches (e.g., switches 608 and 610) to operate the repeater in DL mode.

At step 930, the repeater receives a signal from a BS, and retransmits the signal to one or more UEs.

At step 940, the repeater controls one or more switches (e.g., switches 608 and 610) to operate the repeater in UL mode.

At step 950, the repeater receives a signal from one or more UEs, and retransmits the signal to a BS.

Although FIG. 9 illustrates one example method for operating a MIMO repeater with D-SIC 900, various changes may be made to FIG. 9. For example, while shown as a series of steps, various steps in FIG. 9 could overlap, occur in parallel, occur in a different order, occur any number of times, be omitted, or replaced by other steps.

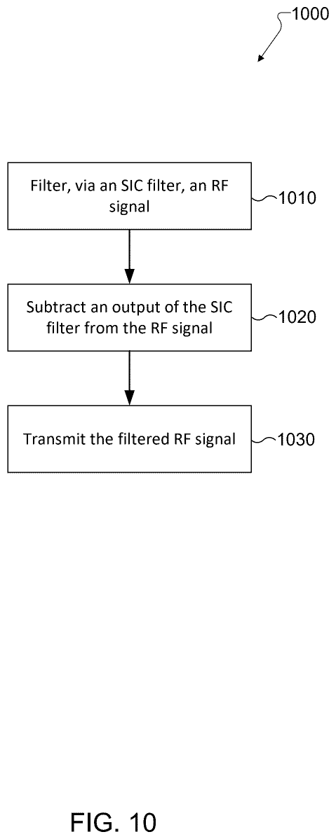

FIG. 10 illustrates another example method for operating a MIMO repeater with D-SIC 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for operating a MIMO repeater with D-SIC could be used without departing from the scope of this disclosure.

In the example of FIG. 10, method 1000 begins at 1010. At step 1010, a MIMO repeater with D-SIC (e.g., repeater 600 of FIG. 6), for each of a plurality of transceiver pairs comprised by the MIMO repeater, filters, via an SIC filter, an RF signal received from one of a first antenna or a second antenna of the transceiver pair.

At step 1020, for each of the plurality of transceiver pairs, the MIMO repeater subtracts an output of the SIC filter from the RF signal to generate a filtered RF signal.

At step 1030, for each of the plurality of transceiver pairs, the MIMO repeater transmits, via the other of the first antenna or the second antenna, the filtered RF signal.

In some embodiments, the MIMO repeater digitizes, via an RFDAC, the RF signal, generating a digital signal. In these embodiments, filtering the RF signal includes filtering the digital signal with the SIC filter, and subtracting the output of the SIC filter from the RF signal to generate a filtered RF signal includes: (1) subtracting the output of the SIC filter from the digital signal, generating a filtered digital signal; and (2) processing, via an RF digital-to-analog converter (RFDAC), the filtered digital signal, generating the filtered RF signal.

In some embodiments, for each of the plurality of transceiver pairs, during forwarding of a downlink transmission from a BS to at least one user equipment UE, the MIMO repeater causes a first SPDT switch to switch the first antenna into an input of a first path of the transceiver pair, and causing a second SPDT switch to switch the second antenna into an output of the first path of the transceiver pair.

In some embodiments, for each of the plurality of transceiver pairs, during forwarding of an uplink transmission from at least one UE to a BS, the MIMO repeater causes the first SPDT switch to switch the first antenna into an output of a second path of the transceiver pair, and causing the second SPDT switch to switch the second antenna into an input of the second path of the transceiver pair.

I some embodiments, the MIMO repeater digitizes, via an RF analog-to-digital converter (RFADC), the RF signal, generating a digital signal. In these embodiments, filtering the RF signal includes filtering the digital signal with the SIC filter, and subtracting the output of the SIC filter from the RF signal to generate a filtered RF signal includes: (1) subtracting the output of the SIC filter from the digital signal, generating a filtered digital signal; and (2) processing, via an RF digital-to-analog converter (RFDAC), the filtered digital signal, generating the filtered RF signal.

In some embodiments, for each of the transceiver pairs, during forwarding of a downlink transmission from a BS to at least one UE, the MIMO repeater causes a first SPDT switch to switch the first antenna into an input of a first path of the transceiver pair, and causes a second SPDT switch to switch the second antenna into an output of the first path of the transceiver pair.

In some embodiments, for each of the transceiver pairs, during forwarding of an uplink transmission from at least one UE to a BS, the MIMO repeater causes the first SPDT switch to switch the first antenna into an output of a second path of the transceiver pair, and causes the second SPDT switch to switch the second antenna into an input of the second path of the transceiver pair.

In some embodiments, the MIMO repeater sounds a channel based on a training sequence stored in a playback memory, estimates the channel based on the sounding, generates, based on the training sequence and the channel estimation, a training result, and for each of the plurality of transceiver pairs, filters the RF signal received from the one of the first antenna or the second antenna according to the training result.

In some embodiments, the MIMO repeater determines whether a self-interference of the MIMO repeater exceeds a threshold, and in response to a determination that the self-interference of the MIMO repeater exceeds the threshold, generates the training result.

In some embodiments, the training result comprises a set of finite impulse response (FIR) complex coefficients.

In some embodiments, to determine the set of FIR complex coefficients, the MIMO repeater may solve for the set of FIR coefficients based on at least one of a least squares problem associated with the channel estimation, a maximum likelihood associated with the channel estimation, and a gradient descent associated with the channel estimation.

Although FIG. 10 illustrates one example method for operating a MIMO repeater with D-SIC 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A multiple-input, multiple-output (MIMO) repeater comprising:
a plurality of transceiver pairs; and
a processor operatively coupled to each of the plurality of transceiver pairs, the processor configured to, for each transceiver pair:
filter, via a self-interference cancellation (SIC) filter, an RF signal received from one of a first antenna or a second antenna of the transceiver pair;
subtract an output of the SIC filter from the RF signal to generate a filtered RF signal; and
transmit, via the other of the first antenna or the second antenna, the filtered RF signal.

2. The MIMO repeater of claim 1, wherein:
the processor is further configured to digitize, via an RF analog-to-digital converter (RFADC), the RF signal, generating a digital signal; and
when the processor filters the RF signal, the processor filters the digital signal with the SIC filter;
when the processor subtracts the output of the SIC filter from the RF signal to generate a filtered RF signal, the processor subtracts the output of the SIC filter from the digital signal, generating a filtered digital signal; and
each transceiver pair comprises an RF digital-to-analog converter (RFDAC) configured to process the filtered digital signal, generating the filtered RF signal.

3. The MIMO repeater of claim 1, wherein each transceiver pair comprises:
a first single pole double throw switch (SPDT) configured to switch the first antenna between a first path of the transceiver pair and a second path of the transceiver pair; and
a second SPDT switch configured to switch the second antenna between the first path of the transceiver pair and the second path of the transceiver pair,
wherein the processor is further configured to:
during forwarding of a downlink transmission from a base station (BS) to at least one UE, cause the first SPDT switch to switch the first antenna into an input of the first path, and cause the second SPDT switch to switch the second antenna into an output of the first path; and
during forwarding of an uplink transmission from the at least one UE to the BS, cause the first SPDT switch to switch the first antenna into an output of the second path, and cause the second SPDT switch to switch the second antenna into an input of the second path.

4. The MIMO repeater of claim 1, wherein:
the MIMO repeater further comprises a playback memory; and
the processor is further configured to:
sound a channel based on a training sequence stored in the playback memory;
estimate the channel based on the sounding;
generate, based on the training sequence and the channel estimation, a training result; and
filter the RF signal received from the one of the first antenna or the second antenna according to the training result.

5. The MIMO repeater of claim 4, wherein the processor is further configured to:
determine whether a self-interference of the MIMO repeater exceeds a threshold; and
in response to a determination that the self-interference of the MIMO repeater exceeds the threshold, generate the training result.

6. The MIMO repeater of claim 4, wherein the training result comprises a set of finite impulse response (FIR) complex coefficients.

7. The MIMO repeater of claim 6, wherein to determine the set of FIR complex coefficients, the processor is further configured to solve for the set of FIR complex coefficients based on at least one of:
a least squares problem associated with the channel estimation;
a maximum likelihood associated with the channel estimation; and
a gradient descent associated with the channel estimation.

8. A method of operating a multiple-input, multiple-output (MIMO) repeater, the method comprising:
for each of a plurality of transceiver pairs comprised by the MIMO repeater:
filtering, via a self-interference cancellation (SIC) filter, an RF signal received from one of a first antenna or a second antenna of the transceiver pair;
subtracting an output of the SIC filter from the RF signal to generate a filtered RF signal; and
transmitting, via the other of the first antenna or the second antenna, the filtered RF signal.

9. The method of claim 8, further comprising digitizing, via an RF analog-to-digital converter (RFADC), the RF signal, generating a digital signal, wherein:
filtering the RF signal comprises filtering the digital signal with the SIC filter; and
subtracting the output of the SIC filter from the RF signal to generate a filtered RF signal comprises:
subtracting the output of the SIC filter from the digital signal, generating a filtered digital signal; and
processing, via an RF digital-to-analog converter (RFDAC), the filtered digital signal, generating the filtered RF signal.

10. The method of claim 8, further comprising:
for each of the plurality of transceiver pairs:
during forwarding of a downlink transmission from a base station (BS) to at least one user equipment (UE), causing a first SPDT switch to switch the first antenna into an input of a first path of the transceiver pair, and causing a second SPDT switch to switch the second antenna into an output of the first path of the transceiver pair; and
during forwarding of an uplink transmission from the at least one UE to the BS, causing the first SPDT switch to switch the first antenna into an output of a second path of the transceiver pair, and causing the second SPDT switch to switch the second antenna into an input of the second path of the transceiver pair.

11. The method of claim 8, further comprising:
sounding a channel based on a training sequence stored in a playback memory;
estimating the channel based on the sounding;
generating, based on the training sequence and the channel estimation, a training result; and
for each of the plurality of transceiver pairs, filtering the RF signal received from the one of the first antenna or the second antenna according to the training result.

12. The method of claim 11, further comprising:
determining whether a self-interference of the MIMO repeater exceeds a threshold; and
in response to a determination that the self-interference of the MIMO repeater exceeds the threshold, generating the training result.

13. The method of claim 11, wherein the training result comprises a set of finite impulse response (FIR) complex coefficients.

14. The method of claim 13, wherein to determine the set of FIR complex coefficients, the method further comprises solving for the set of FIR complex coefficients based on at least one of:
a least squares problem associated with the channel estimation;
a maximum likelihood associated with the channel estimation; and
a gradient descent associated with the channel estimation.

15. A non-transitory computer readable medium embodying a computer program, the computer program comprising program code that, when executed by a processor of a device, causes the device to:
for each of a plurality of transceiver pairs comprised by the device:
filter, via a self-interference cancellation (SIC) filter, an RF signal received from one of a first antenna or a second antenna of the transceiver pair;
subtract an output of the SIC filter from the RF signal to generate a filtered RF signal; and
transmit, via the other of the first antenna or the second antenna, the filtered RF signal.

16. The non-transitory computer readable medium of claim 15, wherein the program code, when executed by the processor of the device, further causes the device to:
for each of the plurality of transceiver pairs:
during forwarding of a downlink transmission from a base station (BS) to at least one user equipment (UE), cause a first SPDT switch to switch the first antenna into an input of a first path of the transceiver pair, and cause a second SPDT switch to switch the second antenna into an output of the first path of the transceiver pair; and
during forwarding of an uplink transmission from the at least one UE to the BS, cause the first SPDT switch to switch the first antenna into an output of a second path of the transceiver pair, and cause the second SPDT switch to switch the second antenna into an input of the second path of the transceiver pair.

17. The non-transitory computer readable medium of claim 15, wherein the program code, when executed by the processor of the device, further causes the device to:
sound a channel based on a training sequence stored in a playback memory;
estimate the channel based on the sounding;
generate, based on the training sequence and the channel estimation, a training result; and
for each of the plurality of transceiver pairs, filter the RF signal received from the one of the first antenna or the second antenna according to the training result.

18. The non-transitory computer readable medium of claim 17, wherein the program code, when executed by the processor of the device, further causes the device to:
determining whether a self-interference of the device exceeds a threshold; and
in response to a determination that the self-interference of the device exceeds the threshold, generating the training result.

19. The non-transitory computer readable medium of claim 17, wherein the training result comprises a set of finite impulse response (FIR) complex coefficients.

20. The non-transitory computer readable medium of claim 19, wherein to determine the set of FIR complex coefficients, the program code, when executed by the processor of the device, further causes the device to solve for the set of FIR complex coefficients based on at least one of:
a least squares problem associated with the channel estimation;
a maximum likelihood associated with the channel estimation; and
a gradient descent associated with the channel estimation.
